(19) United States
(12) Patent Application Publication
(10) Pub. No.: US 2012/0191966 A1
(43) Pub. Date: Jul. 26, 2012

(54) METHODS AND APPARATUS FOR CHANGING THE DUTY CYCLE OF MOBILE DEVICE DISCOVERY BASED ON ENVIRONMENTAL INFORMATION

(75) Inventors: Aleksandar Jovicic, (US); Junyi Li, Chester, NJ (US)

(73) Assignee: QUALCOMM Incorporated, San Diego, CA (US)

(21) Appl. No.: 13/013,286

(22) Filed: Jan. 25, 2011

(51) Int. Cl. G06F 1/24

(52) U.S. Cl. 713/100

(57) ABSTRACT

A method of operating a wireless device includes adjusting at least one duty cycle at which peer discovery signals are sent or received based on environmental information of an environment of the wireless device. In addition, the method includes sending or receiving the peer discovery signals in time based on the at least one duty cycle.

### BACKGROUND

1. Field

The present disclosure relates generally to communication systems, and more particularly, to changing the duty cycle of mobile device discovery based on environmental information.

2. Background

Most mobile devices today include various wireless technologies. Increasingly, smart-phones and ultra-portable devices feature Bluetooth and Wi-Fi radios, along with 3^{rd} generation (3G) wireless wide area network (WWAN) radios. The manufacturers of these radio technologies (and the standards bodies representing them) are recognizing that direct device-to-device communication between mobiles will become increasingly important in the future and, as a result, have chartered efforts in this direction. One example is Wi-Fi Direct, which provides a protocol-level enhancement to IEEE 802.11 that automates and simplifies the creation of peer-to-peer (or device-to-device) communication links. Bluetooth is a registered trademark of Bluetooth SIG, Inc. Wi-Fi and Wi-Fi Direct are trademarks of the Wi-Fi Alliance.

The key predicate for device-to-device communication is device discovery. A device should be able to discover other devices of interest to the device as well as advertise its presence to others. For the overall system to be useful and easy to use, however, device discovery should be autonomous and power efficient. That is, device discovery should be autonomous so that a user does not need to actively intervene in real-time to enable/disable discovery. In addition, device discovery and advertising should be power efficient so as to consume as little battery power as possible in order to maximize the stand-by time of the device.

The FlashLinQ system satisfies both of the above constraints by using time-synchronization and orthogonal frequency division multiplexing (OFDM) techniques. However, FlashLinQ may be further optimized to improve its peer discovery power efficiency. Unlike FlashLinQ, technologies such as Wi-Fi and Bluetooth are unsynchronized. Because Bluetooth and Wi-Fi devices do not share a common knowledge of the times at which discovery signal transmission is scheduled to occur, the devices must remain on constantly (in which case the devices quickly drain the battery) or periodically turn on/off (in which case the devices might not detect others or be detected by others). As such, there is a need in the art to enhance device discovery for technologies such as Wi-Fi, Bluetooth, FlashLinQ, and other technologies.

### SUMMARY

In an aspect of the disclosure, a method of operating a wireless device includes adjusting at least one duty cycle at which peer discovery signals are sent or received based on environmental information of an environment of the wireless device. In addition, the method includes sending or receiving the peer discovery signals in time based on the at least one duty cycle.

### BRIEF DESCRIPTION OF THE DRAWINGS

FIG. 1 is a diagram illustrating an example of a hardware implementation for an apparatus employing a processing system.

FIG. 2 is a drawing of a wireless peer-to-peer communications system.

FIG. 3 is a diagram illustrating a time structure for peer-to-peer communication between the wireless devices.

FIG. 4 is a diagram illustrating the channels in each frame of superframes in one grandframe.

FIG. 5 is a diagram illustrating an operation timeline of a miscellaneous channel and a structure of a peer discovery channel.

FIG. 6 is diagram for illustrating an exemplary method.

FIG. 7 is a diagram for illustrating a second exemplary method.

FIG. 8 is a flow chart of an exemplary method.

FIG. 9 is a flow chart of another exemplary method.

FIG. 10 is a flow chart of yet another exemplary method.

FIG. 11 is a conceptual block diagram illustrating the functionality of an exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc (BD) where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

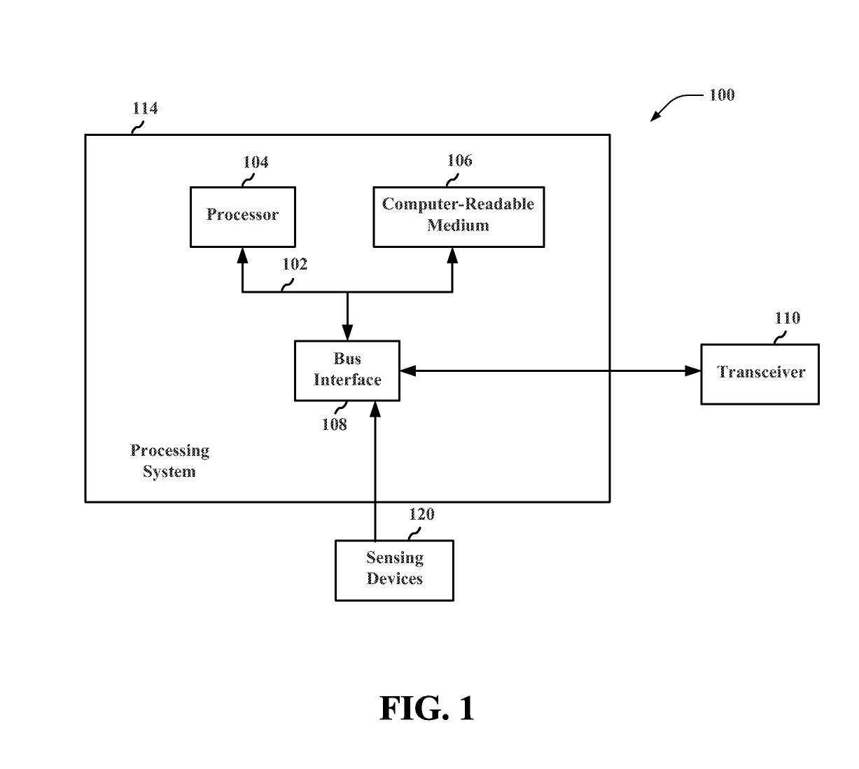

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110 and sensing devices 120. The transceiver 110 provides a means for communicating with various other apparatuses over a transmission medium. The sensing devices 120 provide a means for sensing an environment of the apparatus 100. The sensing devices 120 may include a barometer for measuring air pressure, a gyroscope for determining orientation and rotation, a compass for determining a direction relative to Earth's magnetic poles, Global Position System (GPS) technology for determining velocity, a light sensor for determining a light intensity, a microphone for detecting sound, and/or an acceleration detector for determining acceleration. The sensing devices 120 may include other devices known in the art for determining altitude, motion, acceleration, rotation, velocity, light intensity, sound, and other environmental parameters/conditions of the apparatus 100.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

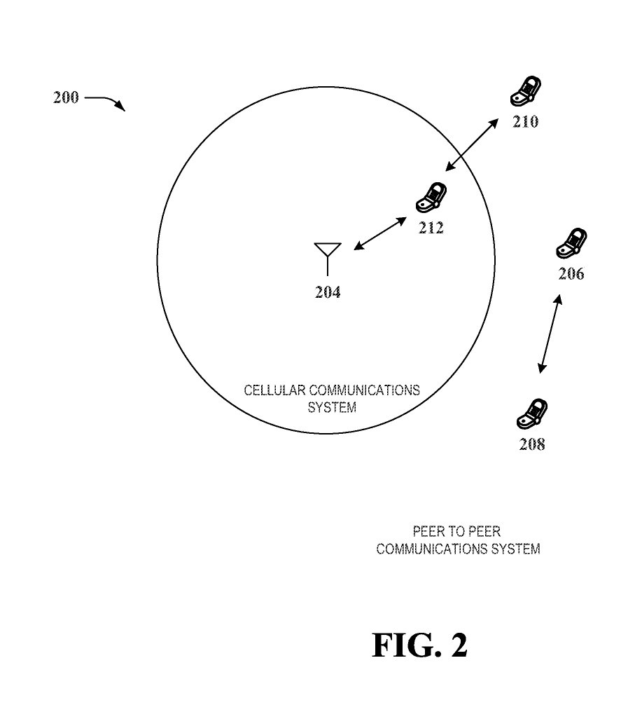

FIG. 2 is a drawing of an exemplary peer-to-peer communications system 200. The peer-to-peer communications system 200 includes a plurality of wireless devices 206, 208, 210, 212. The peer-to-peer communications system 200 may overlap with a cellular communications system, such as for example, a wireless wide area network (WWAN). Some of the wireless devices 206, 208, 210, 212 may communicate together in peer-to-peer communication, some may communicate with the base station 204, and some may do both. For example, as shown in FIG. 2, the wireless devices 206, 208 are in peer-to-peer communication and the wireless devices 210, 212 are in peer-to-peer communication. The wireless device 212 is also communicating with the base station 204.

The wireless device may alternatively be referred to by those skilled in the art as user equipment, a mobile station, a subscriber station, a mobile unit, a subscriber unit, a wireless unit, a wireless node, a remote unit, a mobile device, a wireless communication device, a remote device, a mobile subscriber station, an access terminal, a mobile terminal, a wireless terminal, a remote terminal, a handset, a user agent, a mobile client, a client, or some other suitable terminology. The base station may alternatively be referred to by those skilled in the art as an access point, a base transceiver station, a radio base station, a radio transceiver, a transceiver function, a basic service set (BSS), an extended service set (ESS), a Node B, an evolved Node B, or some other suitable terminology.

The exemplary methods and apparatuses discussed infra are applicable to any of a variety of wireless peer-to-peer communications systems, such as for example, a wireless peer-to-peer communication system based on FlashLinQ, WiMedia, Bluetooth, ZigBee, or Wi-Fi based on the IEEE 802.11 standard. To simplify the discussion, the exemplary methods and apparatus are discussed within the context of FlashLinQ. However, one of ordinary skill in the art would understand that the exemplary methods and apparatuses are applicable more generally to a variety of other wireless peer-to-peer communication systems.

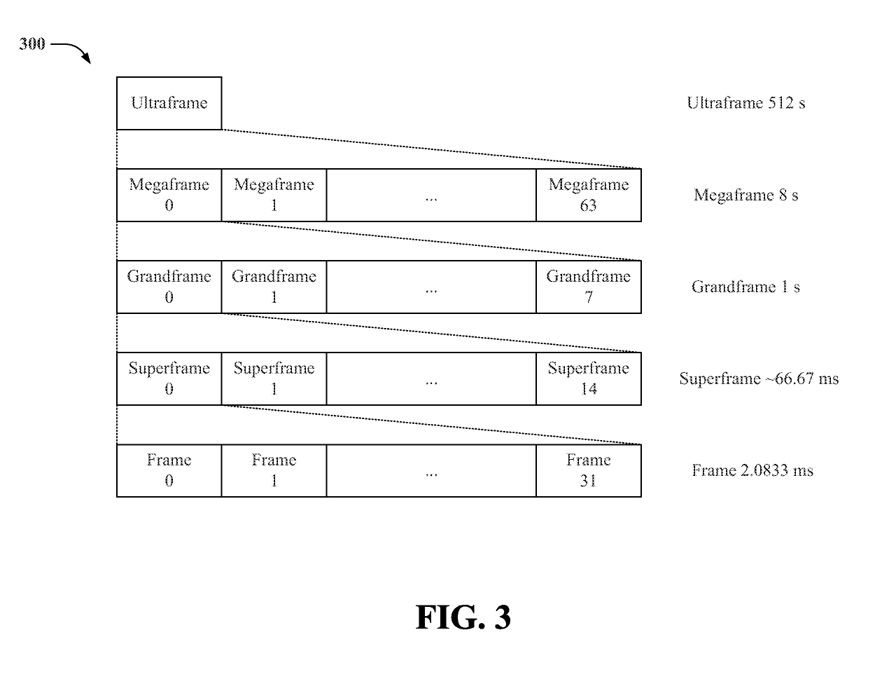

FIG. 3 is a diagram 300 illustrating a time structure for peer-to-peer communication between the wireless devices 100. An ultraframe is 512 seconds and includes 64 megaframes. Each megaframe is 8 seconds and includes 8 grandframes. Each grandframe is 1 second and includes 15 superframes. Each superframe is approximately 66.67 ms and includes 32 frames. Each frame is 2.0833 ms.

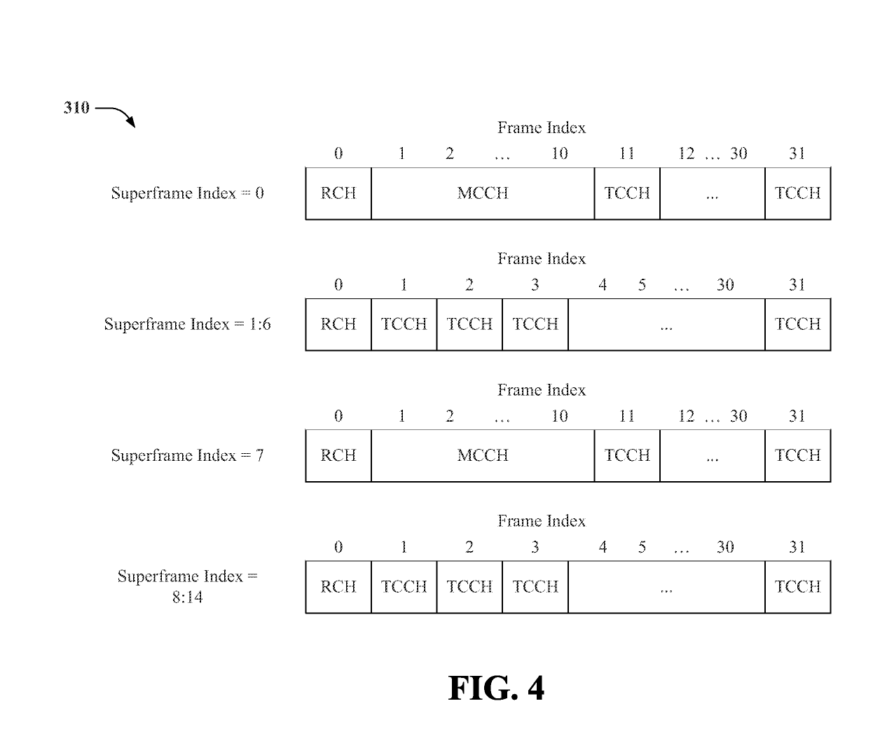

FIG. 4 is a diagram 310 illustrating the channels in each frame of superframes in one grandframe. In a first superframe (with index 0), frame 0 is a reserved channel (RCH), frames 1-10 are each a miscellaneous channel (MCCH), and frames 11-31 are each a traffic channel (TCCH). In the 2^{nd} through 7^{th} superframes (with index 1:6), frame 0 is a RCH and frames 1-31 are each a TCCH. In an 8^{th} superframe (with index 7), frame 0 is a RCH, frames 1-10 are each a MCCH, and frames 11-31 are each a TCCH. In the 9^{th} through 15^{th} superframes (with index 8:14), frame 0 is a RCH and frames 1-31 are each a TCCH. The MCCH of superframe index 0 includes a secondary timing synchronization channel, a peer discovery channel, a peer page channel, and a reserved slot. The MCCH of superframe index 7 includes a peer page channel and reserved slots. The TCCH includes connection scheduling, a pilot, channel quality indicator (CQI) feedback, a data segment, and an acknowledgement (ACK).

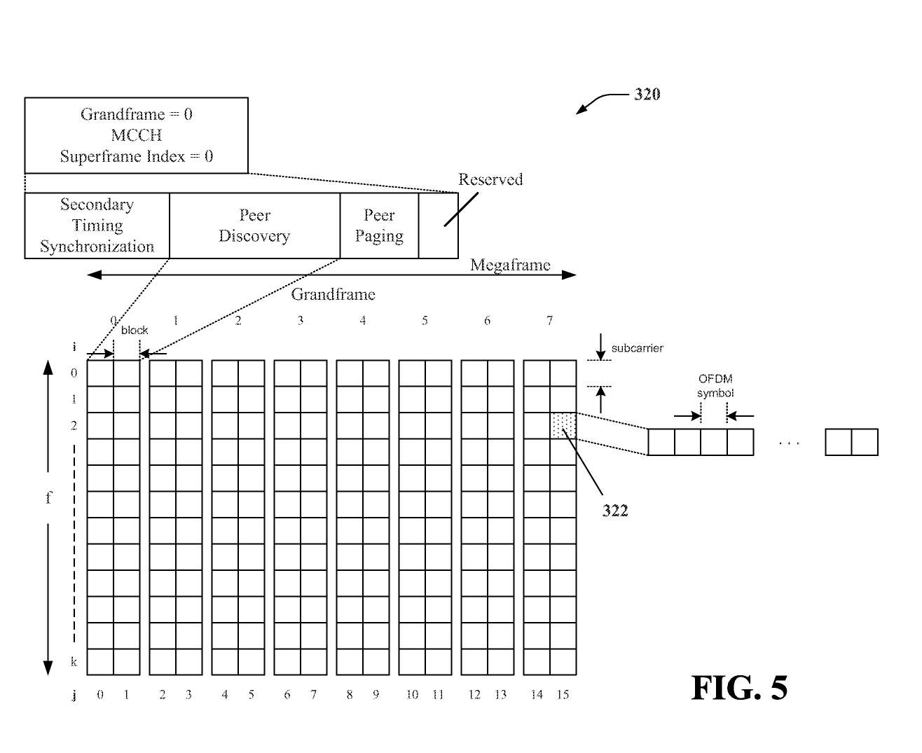

FIG. 5 is a diagram 320 illustrating an operation timeline of the MCCH and an exemplary structure of a peer discovery channel. As discussed in relation to FIG. 4, the MCCH of superframe index 0 includes a secondary timing synchronization channel, a peer discovery channel, a peer paging channel, and a reserved slot. The peer discovery channel may be divided into subchannels. For example, the peer discovery channel may be divided into a long range peer discovery channel, a medium range peer discovery channel, a short range peer discovery channel, and other channels. Each of the subchannels may include a plurality of blocks/resources for communicating peer discovery information. Each block may include a plurality of orthogonal frequency divisional multiplexing (OFDM) symbols at the same subcarrier. FIG. 5 provides an example of a subchannel (e.g., short range peer discovery channel) including blocks in one megaframe, which includes the MCCH superframe index 0 of grandframes 0 through 7. Different sets of blocks correspond to different peer discovery resource identifiers (PDRIDs). For example, one PDRID may correspond to one of the blocks in the MCCH superframe index 0 of one grandframe in the megaframe.

Upon power up, a wireless device listens to the peer discovery channel for a period of time (e.g., two megaframes) and selects a PDRID based on a determined energy on each of the PDRIDs. For example, a wireless device may select a PDRID corresponding to block 322 (i=2 and j=15) in a first megaframe of an ultraframe. The particular PDRID may map to other blocks in other megaframes of the ultraframe due to hopping. In blocks associated with the selected PDRID, the wireless device transmits its peer discovery signal. In blocks unassociated with the selected PDRID, the wireless device listens for peer discovery signals transmitted by other wireless devices.

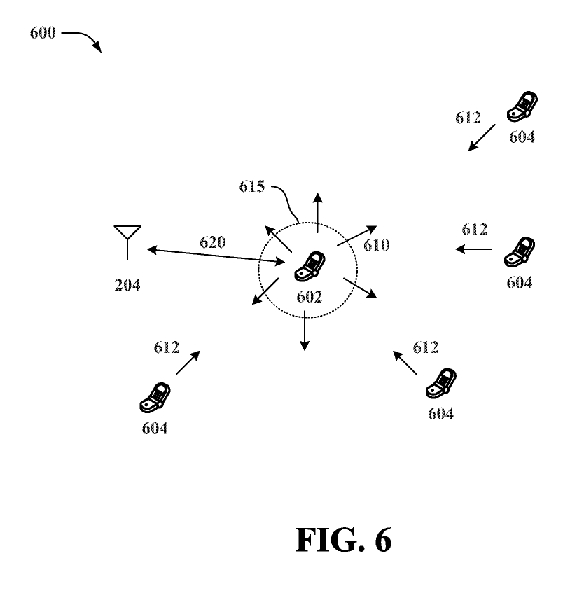

FIG. 6 is diagram 600 for illustrating an exemplary method. As shown in FIG. 6, the wireless device 602 senses its environment 615 to determine environmental information. The environmental information includes at least one of an altitude, motion, acceleration, rotation, a velocity, a light intensity, sound, or a number of discovered peer discovery signals. For example, if the wireless device 602 is traveling in a vehicle at 60 mph, the wireless device 602 may sense a velocity of 60 mph and therefore the environmental information may include a velocity of 60 mph. For another example, if the wireless devices 604 broadcast their peer discovery signals 612, the wireless device 602 may receive four peer discovery signals, and therefore the environmental information may include four discovered peer discovery signals.

According to the exemplary method, the wireless device 602 adjusts at least one duty cycle at which the peer discovery signals 610 are sent or the peer discovery signals 612 are received based on the environmental information of the environment 615 of the wireless device 602. The at least one duty cycle includes a first duty cycle at which the peer discovery signals 610 are sent and/or a second duty cycle at which the peer discovery signals 612 are received. Upon adjusting the at least one duty cycle, the wireless device 602 sends the peer discovery signals 610 or receives the peer discovery signals 612 in time based on the at least one duty cycle.

Referring again to FIG. 5, within a FlashLinQ system, if the wireless device 602 normally transmits/broadcasts once every 8 seconds (i.e., in one peer discovery channel of one grandframe of the eight grandframes in each megaframe), the wireless device 602 can adjust its duty cycle for transmitting/broadcasting its peer discovery signal by not broadcasting in some of the blocks allotted to the wireless device 602. For example, to reduce its duty cycle for transmitting/broadcasting its peer discovery signal, the wireless device 602 may not send its peer discovery signal in n consecutively allocated blocks associated with its PDRID, and therefore may reduce the duty cycle for sending its peer discovery signal to once every 8(n+1) seconds. If the wireless device 602 normally listens for peer discovery signals every one second (i.e., in the peer discovery channel of each grandframe), the wireless device 602 may adjust a duty cycle for receiving peer discovery signals by turning off its receiver and not listening to some of the broadcasts in each peer discovery channel. For example, to reduce its duty cycle for receiving peer discovery signals, the wireless device 602 may not listen for peer discovery signals in n consecutive peer discovery channels, and therefore may reduce the duty cycle for receiving peer discovery signals to once every n+1 seconds. While an example of reducing the at least one duty cycle was presented within the context of FlashLinQ, as discussed supra, the exemplary method is also applicable to Bluetooth, Wi-Fi, and other technologies.

Referring again to FIG. 6, the wireless device 602 senses its environment 615 to determine environmental information that includes at least one of an altitude, motion, acceleration, rotation, a velocity, a light intensity, sound, or a number of discovered peer discovery signals. Based on the environmental information, the wireless device 602 adjusts its at least one duty cycle. When the environmental information includes altitude, the wireless device 602 may decrease the at least one duty cycle when the altitude indicates the wireless device 602 is in flight and may increase the at least one duty cycle otherwise. When in flight, cabin pressure may be adjusted at a certain rate until the final cabin pressure is at a specific pressure (e.g., equivalent to 7000 feet at a cabin pressure of about 11 pounds per square inch). That specific pressure may be obtained when not in flight as well. As such, the altitude environmental information may be determined through the use of both the barometer and GPS technology for determining whether the velocity indicates the wireless device 602 is in flight (e.g., traveling at 500 mph).

When the environmental information includes acceleration, motion, and/or rotation, the wireless device 602 may increase the at least one duty cycle when acceleration, motion, or rotation is detected and may decrease the at least one duty cycle otherwise. If the device does not detect any motion this may indicate that the device is not being physically handled by the user, hence the need for sending and/or receiving peer discovery signals is reduced. The wireless device 602 may utilize the compass, gyroscope, GPS technology, acceleration detector, and/or other devices for detecting motion, rotation, and acceleration of the wireless device 602.

When the environmental information includes velocity, the wireless device 602 may increase the at least one duty cycle when the velocity is determined to be within a range of values and may decrease the at least one duty cycle otherwise. The range of values may be 0 mph to 3 mph, as a velocity outside the range of values may indicate that the wireless device 602 is less likely to communicate with other wireless devices. The wireless device 602 may utilize the GPS technology for determining the velocity of the wireless device 602.

When the environmental information includes light intensity, the wireless device 602 may decrease the at least one duty cycle when the light intensity is less than a threshold and may otherwise increase the duty cycle. A low light intensity may indicate a user of the wireless device 602 is asleep and therefore that the wireless device 602 is less likely to communicate with other wireless devices. The wireless device 602 may utilize the light sensor for determining the light intensity.

When the environmental information includes sound, the wireless device 602 may increase the at least one duty cycle when sound is detected and may decrease the at least one duty cycle otherwise. An environment without sound may indicate that the wireless device 602 is in an inactive environment and therefore in an environment in which communicating with other wireless devices is less likely. The wireless device 602 may utilize the microphone to detected sound.

When the environmental information includes a number of discovered peer discovery signals, the wireless device 602 may decrease the at least one duty cycle when the number of discovered peer discovery signals is less than a threshold and may increase the at least one duty cycle otherwise. A number of discovered peer discovery signals less than a threshold indicates that the wireless device 602 is less likely to communicate with other wireless devices.

As discussed supra, the wireless device 602 senses its environment 615 to determined environmental information. In one configuration, the wireless device 602 sends the environmental information to the base station 204, the base station 204 determines how the wireless device 602 should adjust its at least one duty cycle, and sends a signal to the wireless device 602 with instructions for adjusting the at least one duty cycle. The wireless device 602 then adjusts its at least one duty cycle based on the received instructions from the base station 204. Alternatively, without input from the wireless device 602, the base station 204 may estimate the environmental information 615 of the wireless device 602, determine how the wireless device 602 should adjust its at least one duty cycle, and send instructions to the wireless device 602 for adjusting its at least one duty cycle. For example, the base station 204 may determine that the wireless device 602 is moving with a particular velocity, determine how the at least one duty cycle of the wireless device 602 should be adjusted based on the determined velocity, and send instructions to the wireless device 602 to adjust its at least one duty cycle accordingly.

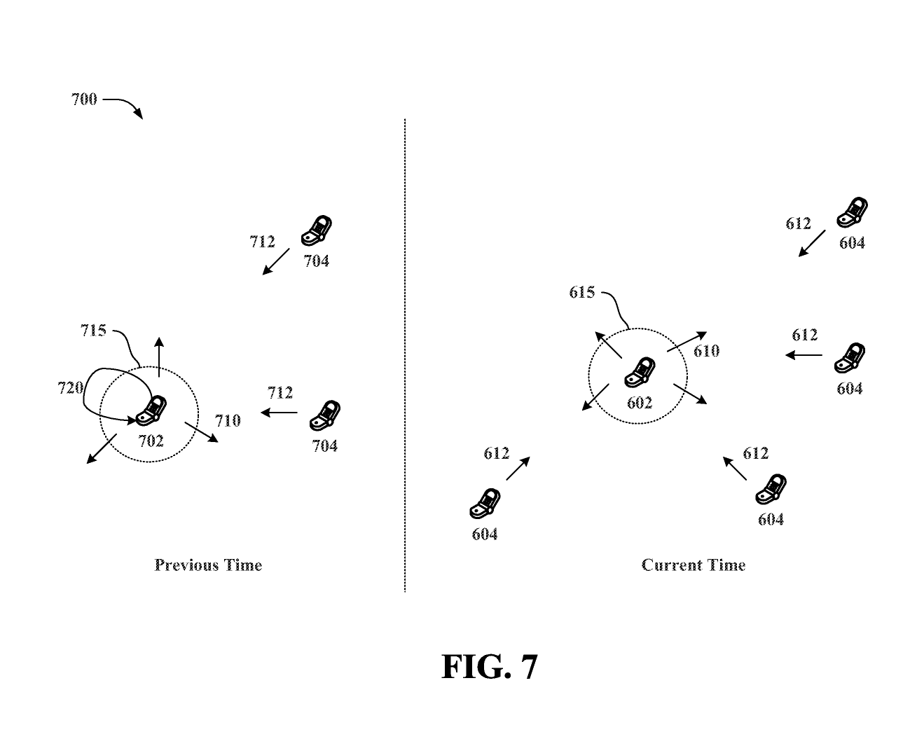

FIG. 7 is a diagram 700 for illustrating a second exemplary method. As shown in FIG. 7, at a previous time, the wireless device 702 sensed its environment 715 to determine environmental information, which includes at least one of an altitude, motion, acceleration, rotation, a velocity, a light intensity, sound, or a number of discovered peer discovery signals 712 from other wireless devices 704. At the previous time, the wireless device 702 adjusted its at least one duty cycle and stored information 720 regarding the adjusted at least one duty cycle and the associated environmental information. At a current time, the wireless device 602 senses its environment 615 to determine environmental information and adjusts its at least one duty cycle based on the environmental information and stored information 720 regarding at least one previous adjusted duty cycle associated with the environmental information. As such, in one configuration, the wireless device 602 is able to learn from previous experiences how to adjust its at least one duty cycle and adjust its at least one duty cycle based on what was learned.

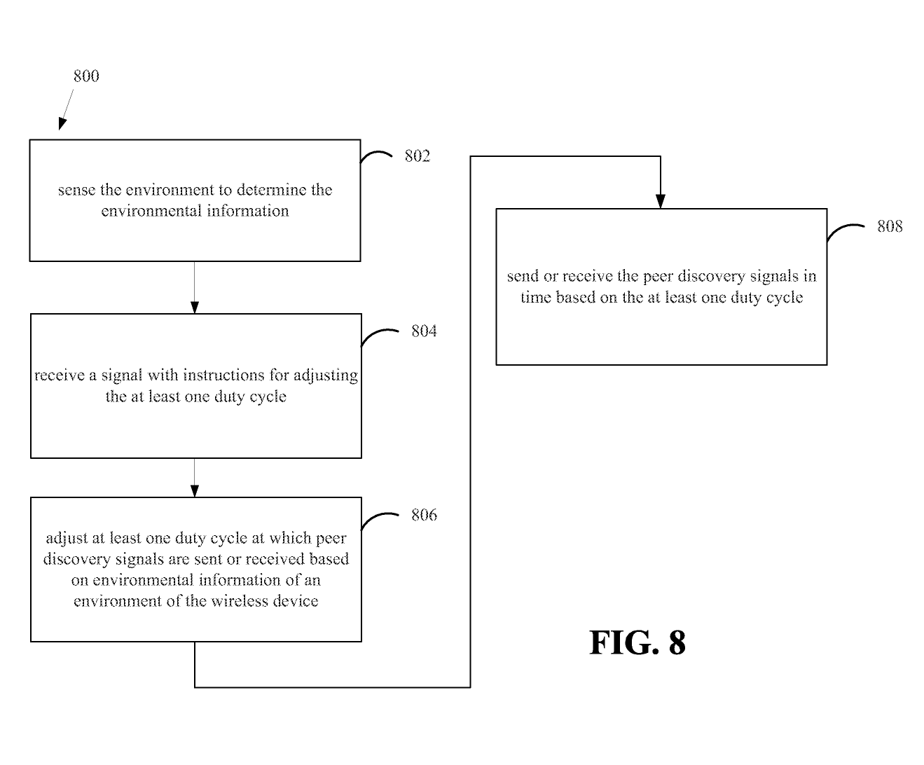

FIG. 8 is a flow chart 800 of an exemplary method. The method is performed by a wireless device 602. As shown in FIG. 8, the wireless device 602 may sense the environment to determine the environmental information (802). In addition, the wireless device may receive a signal with instructions for adjusting the at least one duty cycle (804). The wireless device may sense its own environment and send the environmental information to a base station, which sends back instructions for adjusting the at least one duty cycle. As such, the environmental information may comprise a signal received from another device with the signal containing instructions for adjusting the at least one duty cycle. In another configuration, the base station unilaterally determines the environmental information and sends instructions for adjusting the at least one duty cycle based on the determined environmental information. In yet another configuration, the wireless device 602 itself determines how to adjust the at least one duty cycle without communicating with a base station. In such a configuration, step 804 is not performed. The wireless device 602 then adjusts at least one duty cycle at which peer discovery signals are sent or received based on environmental information of the environment of the wireless device 602 (806). The wireless device 602 sends or receives the peer discovery signals in time based on the adjusted at least one duty cycle (808).

The environmental information includes at least one of an altitude, motion, acceleration, rotation, a velocity, a light intensity, sound, or a number of discovered peer discovery signals. The environmental information may include other measurable environmental parameters if those measurable environmental parameters could indicate that the wireless device 602 is less likely to communicate with other wireless devices.

When the environmental information includes altitude, the wireless device 602 may decrease the at least one duty cycle when the altitude indicates the wireless device is in flight and increase the at least one duty cycle otherwise. When the environmental information includes motion, rotation, and/or acceleration, the wireless device 602 may increase the at least one duty cycle when motion, rotation, and/or acceleration is detected and decrease the at least one duty cycle otherwise. When the environmental information includes velocity, the wireless device 602 may increase the at least one duty cycle when the velocity is determined to be within a range of values and decrease the at least one duty cycle otherwise. When the environmental information includes light intensity, the wireless device 602 may decrease the at least one duty cycle when the light intensity is less than a threshold and increase the at least one duty cycle otherwise. When the environmental information includes sound, the wireless device 602 may increase the at least one duty cycle when sound is detected and decrease the at least one duty cycle otherwise. When the environmental information includes a number of discovered peer discovery signals, the wireless device 602 may decrease the at least one duty cycle when the number of discovered peer discovery signals is less than a threshold and increase the at least one duty cycle otherwise.

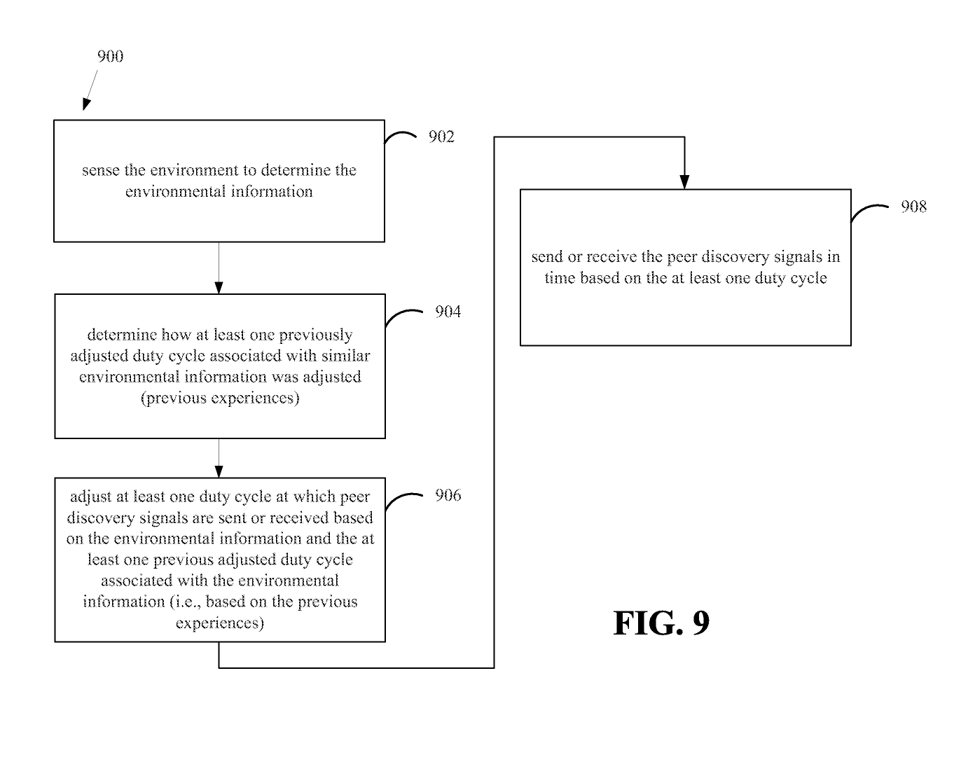

FIG. 9 is a flow chart 900 of another exemplary method. As shown in FIG. 9, the wireless device 602 senses the environment to determine environmental information (902). The wireless device 602 determines how at least one previously adjusted duty cycle associated with similar environmental information was adjusted (904). The stored information of adjusted duty cycles and associated environmental information may be considered “previous experiences.” For example, at a time t₁, the wireless device 602 determines to decrease a duty cycle for transmitting/broadcasting peer discovery signals to D when a number of detected peer discovery signals are less than ten. At a time t₂ later than t₁, the wireless device 602 determines that there are five discovered peer discovery signals. In such a situation, in step 904, the wireless device 904 would determine that when there were ten discovered peer discovery signals, the wireless device 602 adjusted the duty cycle for transmitting/broadcasting peer discovery signals to D. The wireless device 602 then adjusts the duty cycle at which peer discovery signals are sent based on the environmental information (i.e., five discovered peer discovery signals) and the at least one previous adjusted duty cycle (i.e., D) associated with the environmental information (i.e., ten discovered peer discovery signals) (906). For example, assuming the wireless device 602 determined that the previously adjusted duty cycle of D was adequate for the ten discovered peer discovery signals, the wireless device 602 may set the duty cycle to a value less than D based on the newly determined environmental information of five discovered peer discovery signals being less than ten discovered peer discovery signals. Upon adjusting the at least one duty cycle (906), the wireless device 908 sends or receives the peer discovery signals in time based on the adjusted at least one duty cycle (908).

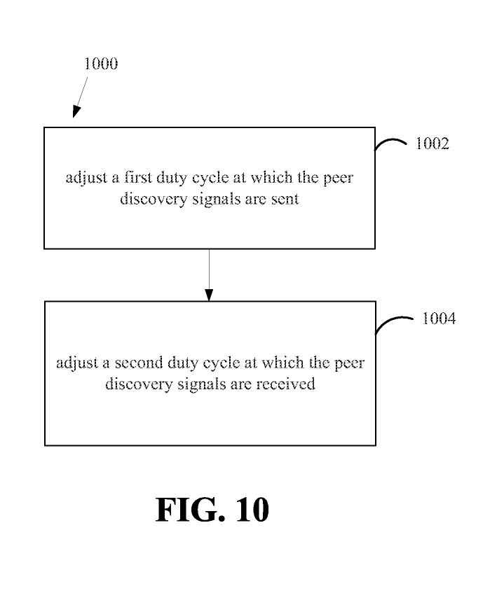

FIG. 10 is a flow chart 1000 of yet another exemplary method. As shown in FIG. 10, the wireless device 602 may adjust the at least one duty cycle in steps 806, 906 by adjusting a first duty cycle at which the peer discovery signals are sent (1002) and/or adjusting a second duty cycle at which the peer discovery signals are received (1004).

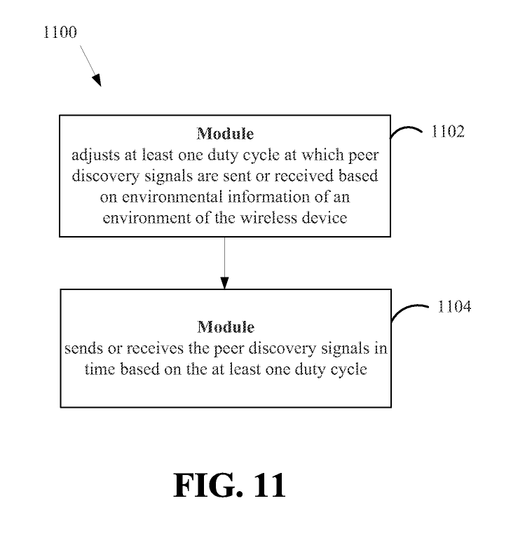

FIG. 11 is a conceptual block diagram 1100 illustrating the functionality of an exemplary apparatus 100. The apparatus 100 includes a module 1102 that adjusts at least one duty cycle at which peer discovery signals are sent or received based on environmental information of an environment of the wireless device. In addition, the apparatus 100 includes a module 1104 that sends or receives the peer discovery signals in time based on the at least one duty cycle. The apparatus 100 may include additional modules that perform each of the steps in the aforementioned flow charts. As such, each step in the aforementioned flow charts may be performed by a module and the apparatus 100 may include one or more of those modules.

Referring to FIG. 1, in one configuration, the apparatus 100 for wireless communication includes means for adjusting at least one duty cycle at which peer discovery signals are sent or received based on environmental information of an environment of the apparatus. In addition, the apparatus 100 includes means for sending or receiving the peer discovery signals in time based on the at least one duty cycle. The apparatus 100 may further include means for sensing the environment to determine the environmental information. The apparatus 100 may further include means for receiving a signal with instructions for adjusting the at least one duty cycle. In one configuration, the means for adjusting the at least one duty cycle includes means for adjusting a first duty cycle at which the peer discovery signals are sent, and means for adjusting a second duty cycle at which the peer discovery signals are received. The aforementioned means is the processing system 114 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a wireless device, comprising:
adjusting at least one duty cycle at which peer discovery signals are sent or received based on environmental information of an environment of the wireless device; and
sending or receiving the peer discovery signals in time based on the at least one duty cycle.

2. The method of claim 1, wherein the environmental information comprises at least one of an altitude, motion, acceleration, rotation, a velocity, a light intensity, sound, or a number of discovered peer discovery signals.

3. The method of claim 2, wherein:
the at least one duty cycle is decreased when the altitude indicates the wireless device is in flight and is increased otherwise when the environmental information comprises the altitude;
the at least one duty cycle is increased when motion is detected and is decreased otherwise when the environmental information comprises motion;
the at least one duty cycle is increased when the velocity is determined to be within a range of values and is decreased otherwise when the environmental information comprises the velocity;
the at least one duty cycle is decreased when the light intensity is less than a threshold and is increased otherwise when the environmental information comprises the light intensity;
the at least one duty cycle is increased when sound is detected and is decreased otherwise when the environmental information comprises sound;
the at least one duty cycle is decreased when a number of discovered peer discovery signals is less than a threshold and is increased otherwise when the environmental information comprises the number of discovered peer discovery signals;
the at least one duty cycle is increased when acceleration is detected and is decreased otherwise when the environmental information comprises acceleration; and
the at least one duty cycle is increased when rotation is detected and is decreased otherwise when the environmental information comprises rotation.

4. The method of claim 1, further comprising sensing the environment to determine the environmental information.

5. The method of claim 1, wherein the environmental information comprises a signal received from another device, said signal containing instructions for adjusting said at least one duty cycle.

6. The method of claim 1, wherein the adjusted at least one duty cycle is further based on at least one previous adjusted duty cycle associated with the environmental information.

7. The method of claim 1, wherein the adjusting the at least one duty cycle comprises:
adjusting a first duty cycle at which the peer discovery signals are sent; and
adjusting a second duty cycle at which the peer discovery signals are received.

8. An apparatus for wireless communication, comprising:
means for adjusting at least one duty cycle at which peer discovery signals are sent or received based on environmental information of an environment of the apparatus; and
means for sending or receiving the peer discovery signals in time based on the at least one duty cycle.

9. The apparatus of claim 8, wherein the environmental information comprises at least one of an altitude, motion, acceleration, rotation, a velocity, a light intensity, sound, or a number of discovered peer discovery signals.

10. The apparatus of claim 9, wherein:
the at least one duty cycle is decreased when the altitude indicates the apparatus is in flight and is increased otherwise when the environmental information comprises the altitude;
the at least one duty cycle is increased when motion is detected and is decreased otherwise when the environmental information comprises motion;
the at least one duty cycle is increased when the velocity is determined to be within a range of values and is decreased otherwise when the environmental information comprises the velocity;
the at least one duty cycle is decreased when the light intensity is less than a threshold and is increased otherwise when the environmental information comprises the light intensity;
the at least one duty cycle is increased when sound is detected and is decreased otherwise when the environmental information comprises sound;
the at least one duty cycle is decreased when a number of discovered peer discovery signals is less than a threshold and is increased otherwise when the environmental information comprises the number of discovered peer discovery signals;
the at least one duty cycle is increased when acceleration is detected and is decreased otherwise when the environmental information comprises acceleration; and
the at least one duty cycle is increased when rotation is detected and is decreased otherwise when the environmental information comprises rotation.

11. The apparatus of claim 8, further comprising means for sensing the environment to determine the environmental information.

12. The apparatus of claim 8, wherein the environmental information comprises a signal received from another device, said signal containing instructions for adjusting said at least one duty cycle.

13. The apparatus of claim 8, wherein the adjusted at least one duty cycle is further based on at least one previous adjusted duty cycle associated with the environmental information.

14. The apparatus of claim 8, wherein the means for adjusting the at least one duty cycle comprises:
means for adjusting a first duty cycle at which the peer discovery signals are sent; and
means for adjusting a second duty cycle at which the peer discovery signals are received.

15. A computer program product in a wireless device, comprising:
a computer-readable medium comprising code for:
adjusting at least one duty cycle at which peer discovery signals are sent or received based on environmental information of an environment of the wireless device; and
sending or receiving the peer discovery signals in time based on the at least one duty cycle.

16. The computer program product of claim 15, wherein the environmental information comprises at least one of an altitude, motion, acceleration, rotation, a velocity, a light intensity, sound, or a number of discovered peer discovery signals.

17. The computer program product of claim 16, wherein:
the at least one duty cycle is decreased when the altitude indicates the wireless device is in flight and is increased otherwise when the environmental information comprises the altitude;
the at least one duty cycle is increased when motion is detected and is decreased otherwise when the environmental information comprises motion;
the at least one duty cycle is increased when the velocity is determined to be within a range of values and is decreased otherwise when the environmental information comprises the velocity;
the at least one duty cycle is decreased when the light intensity is less than a threshold and is increased otherwise when the environmental information comprises the light intensity;
the at least one duty cycle is increased when sound is detected and is decreased otherwise when the environmental information comprises sound;
the at least one duty cycle is decreased when a number of discovered peer discovery signals is less than a threshold and is increased otherwise when the environmental information comprises the number of discovered peer discovery signals;
the at least one duty cycle is increased when acceleration is detected and is decreased otherwise when the environmental information comprises acceleration; and
the at least one duty cycle is increased when rotation is detected and is decreased otherwise when the environmental information comprises rotation.

18. The computer program product of claim 15, wherein the computer-readable medium further comprises code for sensing the environment to determine the environmental information.

19. The computer program product of claim 15, wherein the environmental information comprises a signal received from another device, said signal containing instructions for adjusting said at least one duty cycle.

20. The computer program product of claim 15, wherein the adjusted at least one duty cycle is further based on at least one previous adjusted duty cycle associated with the environmental information.

21. The computer program product of claim 15, wherein the code for adjusting the at least one duty cycle comprises code for:
adjusting a first duty cycle at which the peer discovery signals are sent; and
adjusting a second duty cycle at which the peer discovery signals are received.

22. An apparatus for wireless communication, comprising:
a processing system configured to:
adjust at least one duty cycle at which peer discovery signals are sent or received based on environmental information of an environment of the apparatus; and
send or receiving the peer discovery signals in time based on the at least one duty cycle.

23. The apparatus of claim 22, wherein the environmental information comprises at least one of an altitude, motion, acceleration, rotation, a velocity, a light intensity, sound, or a number of discovered peer discovery signals.

24. The apparatus of claim 23, wherein:
the at least one duty cycle is decreased when the altitude indicates the wireless device is in flight and is increased otherwise when the environmental information comprises the altitude;
the at least one duty cycle is increased when motion is detected and is decreased otherwise when the environmental information comprises motion;
the at least one duty cycle is increased when the velocity is determined to be within a range of values and is decreased otherwise when the environmental information comprises the velocity;
the at least one duty cycle is decreased when the light intensity is less than a threshold and is increased otherwise when the environmental information comprises the light intensity;
the at least one duty cycle is increased when sound is detected and is decreased otherwise when the environmental information comprises sound;
the at least one duty cycle is decreased when a number of discovered peer discovery signals is less than a threshold and is increased otherwise when the environmental information comprises the number of discovered peer discovery signals;
the at least one duty cycle is increased when acceleration is detected and is decreased otherwise when the environmental information comprises acceleration; and
the at least one duty cycle is increased when rotation is detected and is decreased otherwise when the environmental information comprises rotation.

25. The apparatus of claim 22, wherein the processing system is further configured to sense the environment to determine the environmental information.

26. The apparatus of claim 22, wherein the environmental information comprises a signal received from another device, said signal containing instructions for adjusting said at least one duty cycle.

27. The apparatus of claim 22, wherein the adjusted at least one duty cycle is further based on at least one previous adjusted duty cycle associated with the environmental information.

28. The apparatus of claim 22, wherein to adjust the at least one duty cycle, the processing system is configured to:
adjust a first duty cycle at which the peer discovery signals are sent; and
adjust a second duty cycle at which the peer discovery signals are received.
